(19) United States
(12) Patent Application Publication
(10) Pub. No.: US 2014/0126060 A1
(43) Pub. Date: May 8, 2014

(54) DIFFRACTION GRATING AND OPTICAL DEVICE USING SAME

(71) Applicant: CANON KABUSHIKI KAISHA, Tokyo (JP)

(72) Inventor: Takashi Seki, Utsunomiya-shi (JP)

(73) Assignee: CANON KABUSHIKI KAISHA, Tokyo (JP)

(21) Appl. No.: 14/070,693

(22) Filed: Nov. 4, 2013

(30) Foreign Application Priority Data
Nov. 6, 2012 (JP) 2012-244279

(51) Int. Cl. G02B 5/18

(52) U.S. Cl. CPC G02B 5/1866
USPC 359/569

(57) ABSTRACT

The diffraction grating is a transmission-type diffraction grating having a repeating structure of projection and recess on at least one surface of a substrate. A sub-structure of which the cross section is approximated as a triangle or a trapezoid is provided in the recess. The height H of the projection and the height h of the sub-structure are set such that the ratio of the height h of the sub-structure to the height H of the projection is in the range of from 0.05 to 0.45.

### BACKGROUND OF THE INVENTION

1. Field of the Invention

The present invention relates to a diffraction grating and an optical device using the same.

2. Description of the Related Art

Conventionally, a diffraction grating has been used as a wavelength dispersive element in an optical device such as a spectroscope, a pulse compression device, or the like. In particular, a binary transmission type diffraction grating having a pitch in the order of used wavelength has the features of high diffraction efficiency, high dispersion, and the like. The diffraction grating having a repeating structure of projection (convex portion) and recess (concave portion) on the cross section thereof is typically produced by the following procedure. Firstly, a transparent substrate in which a grating shape is to be formed is prepared, and a resist (photosensitizer) is coated on the substrate. Next, a binary pattern is exposed (transferred) onto the resist using a projection exposure device, a two-light flux interference exposure device, or the like. Then, a one-dimensional groove is finally formed on the substrate using an etching device so as to complete a diffraction grating having a desired grating shape. However, the binary-shaped recess (in particular, bottom) formed by etching processing may not be flattened but a portion in a triangle shape or in a trapezoidal shape may remain. When a projection formed in a desired binary pattern is called as a main structure, the remaining portion may also be called as a sub-structure. In consideration of another viewpoint of the sub-structure, it can also be seen that a small groove is formed between the main structure and the sub-structure. The small groove is typically referred to as a “micro-trench”. In particular, it is known that the small groove has an inter-grating pitch in the order of wavelength and pronouncedly appears if the aspect ratio of the grating width to the grating depth increases. Thus, as a method for suppressing the occurrence of such a micro-trench, Japanese Patent Laid-Open No. 2003-234328 discloses an etching method in which a projection consists of two portions, namely a masking material layer and a silicon oxide film, and a corner portion substantially perpendicular to the lower silicon oxide film is formed.

However, in the etching method disclosed in Japanese Patent Laid-Open No. 2003-234328, the occurrence of a micro-trench may be suppressed but damage may occur on the side wall of the projection. FIG. 6 is a cross-sectional view illustrating the shape of a conventional diffraction grating 100 as a reference. Here, the term “side wall damage” refers to, for example, the fact that a two-stage taper portion may occur on the side wall of a projection 100a as shown in FIG. 6. The occurrence of such side wall damage is undesirable because the diffraction efficiency may decrease.

### SUMMARY OF THE INVENTION

The present invention has been developed in consideration of the circumstances described above, and it is an object of the present invention to provide a diffraction grating that suppresses reduction in diffraction efficiency or improves diffraction efficiency even when a sub-structure which is different from the main structure constituting a projection of the diffraction grating is present.

According to an aspect of the present invention, a transmission-type diffraction grating having a repeating structure of projection and recess on at least one surface of a substrate is provided, wherein a sub-structure of which the cross section is approximated as a triangle or a trapezoid and the height of the projection is provided in the recess, and the height of the sub-structure are set such that the ratio of the height of the sub-structure to the height of the projection is in the range of from 0.05 to 0.45.

According to the present invention, a diffraction grating that suppresses reduction in diffraction efficiency or improves diffraction efficiency even when a sub-structure which is different from the main structure constituting a projection of the diffraction grating is present may be provided.

Further features of the present invention will become apparent from the following description of exemplary embodiments with reference to the attached drawings.

### BRIEF DESCRIPTION OF THE DRAWINGS

FIG. 1 is a diagram illustrating the shape of a diffraction grating according to a first embodiment of the present invention.

FIG. 2 is a graph illustrating the effects of the diffraction grating according to the first embodiment.

FIG. 3 is a diagram illustrating the shape of a diffraction grating according to a second embodiment of the present invention.

FIG. 4 is a graph illustrating the effects of the diffraction grating according to the second embodiment.

FIG. 5 is a diagram illustrating a configuration of an optical device according to one embodiment of the present invention.

FIG. 6 is a diagram illustrating the shape of a conventional diffraction grating.

### DESCRIPTION OF THE EMBODIMENTS

Hereinafter, preferred embodiments of the present invention will now be described in detail with reference to the accompanying drawings.

### First Embodiment

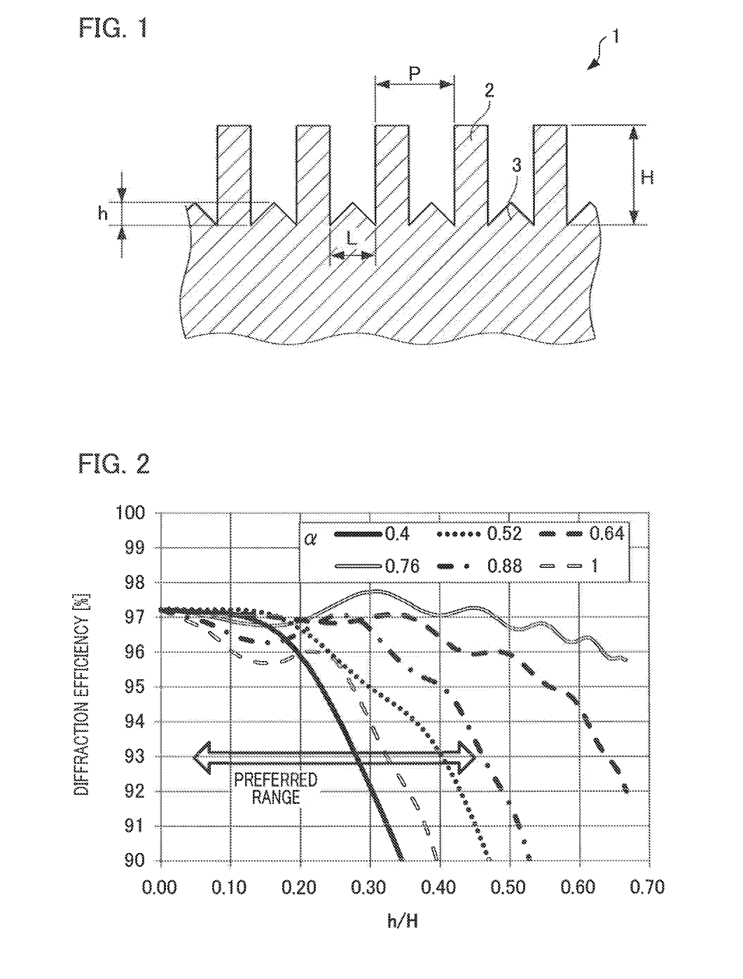

Firstly, a description will be given of a diffraction grating according to a first embodiment of the present invention. In particular, an assumption is made that the diffraction grating of the present embodiment is a binary transmission type diffraction grating. FIG. 1 is a cross-sectional view illustrating a part of the shape of a diffraction grating 1 according to the present embodiment. The diffraction grating 1 has a repeating structure of a plurality of rectangular projections (hereinafter referred to as “main structure”) 2 and a plurality of sites (hereinafter referred to as “sub-structure”) 3, each of which is particularly formed at the bottom of the recess between two adjacent main structures 2 and has a shape approximated by a triangle as an example, on the cross section thereof. The diffraction grating 1 is designed by using a used wavelength, a substrate refractive index, an inter-grating pitch, a grating depth, duty, and the like as parameters. The used wavelength is determined on the basis of a wavelength range into which light is desired to be split. The substrate refractive index is selected by a medium having a high transmittance in a used wavelength range. Examples of a medium employable as a substrate include, for example, SiO₂, Al₂O₃, TiO₂, Si, and the like. Here, a binary transmission type diffraction grating such as the diffraction grating 1 is typically used in a system called as a Littrow arrangement where an incidence angle is equal to a diffraction angle. The diffraction order at this time is typically selected from positive first-order light or negative first-order light. Then, an inter-grating pitch P and an incidence angle that satisfy the conditions of the following formula are selected on the basis of a wavelength, a substrate refractive index, and a diffraction order that have been previously selected.

λ₁/2 sin θₗᵢₜ<P<λₕ/2 sin θₗᵢₜ

Here, θₗᵢₜ denotes an incidence angle or a diffraction angle, λ₁ denotes the lower limit of the wavelength range, and λₕ denotes the upper limit of the wavelength range. Note that, since θₗᵢₜ is often selected in the range of from 20° to 60°, the inter-grating pitch P is in the order of wavelength. Next, since the inter-grating pitch P is in the order of wavelength, electromagnetic field analysis instead of scalar analysis is used for calculating a diffraction efficiency with respect to a grating depth H and a duty σ. Here, the duty σ is the ratio of the width of the main structure to the inter-grating pitch P. Among the electromagnetic field analyses, RCWA (rigorous coupled wave analysis) may also be used in the case of an optical element without involving a nonlinearity effect.

In particular, in the present embodiment, the main structure 2 and the sub-structure 3 are set (formed) so as to have the following dimension. Firstly, the main structure 2 has an inter-grating pitch P of 800 nm and a duty σ of 0.425. In contrast, the sub-structure 3 is approximated by a triangle having a height of h and a base L of the product of P×(1−σ). Here, a grating depth (hereinafter referred to as “reference grating depth”) H₁ of 1.5 μm when the height h=0 μm, that is, the sub-structure 3 is not present is a preferred design value when the diffraction grating 1 is used in a wavelength λ of 1,030 nm at an incidence angle of 40°. Note that the diffraction efficiency (hereinafter referred to as “reference diffraction efficiency”) e₁ at this time is 97.2% as a calculated value.

Next, a parameter α is introduced in relation to the ratio of the height h of the sub-structure 3 to the grating depth H of the main structure 2 so as to reference the diffraction efficiency e for each parameter α. FIG. 2 is a graph illustrating the diffraction efficiency e (unit %) with respect to the ratio (h/H) of the height h to the grating depth H for each parameter α. Here, the parameter α is defined based on the assumption that the grating depth H, the height h, and the reference grating depth H₁ are in the relationship of H=H₁+α×h. It can be seen from FIG. 2 that the diffraction efficiency e with respect to the ratio h/H depends on the parameter α. At this time, the diffraction efficiency e overall tends to decrease with an increase in the ratio h/H. However, the diffraction efficiency e locally increases greater than the reference diffraction efficiency e₁ in a range where the ratio h/H is from 0.20 to 0.45 inclusive when the parameter α (parameter value) is, for example, 0.76. When the parameter α is 0.64, the diffraction efficiency e is substantially equal to the reference diffraction efficiency e₁ at the ratio h/H of 0.32. Likewise, when the parameter α is 0.88, the diffraction efficiency e is substantially equal to the reference diffraction efficiency e₁ at the ratio h/H of 0.26. Furthermore, when the parameter α is 0.52, the diffraction efficiency e increases greater than the reference diffraction efficiency e₁ in a range where the ratio h/H is from 0.05 to 0.15 inclusive. In other words, if the diffraction grating 1 is formed by setting the target dimension such that the parameter α and the ratio h/H fall within such a range or a value, high diffraction efficiency e may be obtained (the reduction in the diffraction efficiency e may be suppressed) even when the sub-structure 3 is present.

Next, a description will be given of procedure for forming the diffraction grating 1. Firstly, a transparent substrate for forming the diffraction grating 1 is prepared. As the transparent substrate, a substrate consisting of, for example, quartz may be employed. A resist (photosensitizer) is coated on the transparent substrate (coating step). At this time, the resist is coated such that the film thickness is thicker than the product of the grating depth H and (mask etching rate/substrate etching rate). Next, an L/S pattern in a grating shape with a pitch of 800 nm is transferred onto the transparent substrate using, for example, a KrF exposure device (optical magnification: ¼) (exposing step). A photo mask (original) used upon pattern transfer has an L/S pattern with a pitch of 3200 nm which is four times greater than a designed pitch of 800 nm. At this time, the amount of exposure from the exposure device is adjusted by taking into account the characteristic of the resist so as to achieve the duty σ of 0.425. When an offset occurs in the pitch of the photo mask due to manufacturing tolerances, such offset may be corrected by adjusting exposure magnification. Next, the etching device performs dry etching processing for the transparent substrate on which the L/S pattern is formed (etching step). At this time, the etching device adjusts the type, the flow rate, and the etching time of etching gas as appropriate. Halogenated gas, rare gas, oxygen, or the like may be selected as etching gas. The flow rate and the etching time may be adjusted by changing a bias power for applied voltage and a voltage applying time. Then, the transparent substrate subjected to etching in the etching step is cleaned by using an organic solvent such as acetone or liquid such as pure water (cleaning step). By these steps, the diffraction grating 1 formed in a grating shape having the inter-grating pitch P of 800 nm is formed. Note that, since the parameter α varies depending on an environment of various devices, the parameter α needs to be determined by performing preliminary processing prior to the forming step of forming a final diffraction grating 1. For example, after once forming the diffraction grating 1, the shape of the diffraction grating 1 is observed by a scanning electron microscope (SEM), so that a desired parameter α may be finally determined by trial and error.

In the diffraction grating 1, when a grating shape is only formed on one side (one surface) of the transparent substrate, an anti-reflection film or an anti-reflection structure (SWS) may be formed on the other side of the transparent substrate. In this case, an anti-reflection film or an anti-reflection structure may be formed in advance on the transparent substrate prior to forming the diffraction grating 1 or may also be formed after forming the diffraction grating 1 as described above (after the cleaning step is ended). Furthermore, when a grating shape is formed on both sides of the transparent substrate, the grating shape is also formed on the back side of the transparent substrate by performing, in sequence, the coating step, the exposing step, and the etching step.

As described above, by assuming the fact that the sub-structure 3 is present in the diffraction grating 1 in advance, the grating depth H and the height h of the sub-structure 3 are set such that the ratio h/H of the height h of the sub-structure 3 to the grating depth H falls within the range or value as described above. With this arrangement, even when the sub-structure 3 is present, the reduction in the diffraction efficiency e can be suppressed or the diffraction efficiency e can further be improved greater than the case where the sub-structure 3 is not present. In particular, in the present embodiment, the grating depth H and the height h of the sub-structure 3 are set as appropriate in advance, resulting in no side wall damage on a projection (the main structure 2) upon conventional formation.

As described above, according to the present embodiment, the diffraction grating 1 that suppresses reduction in the diffraction efficiency e or improves the diffraction efficiency e even when the sub-structure 3 which is different from the main structure 2 constituting the projection in a grating shape is present may be provided.

### Second Embodiment

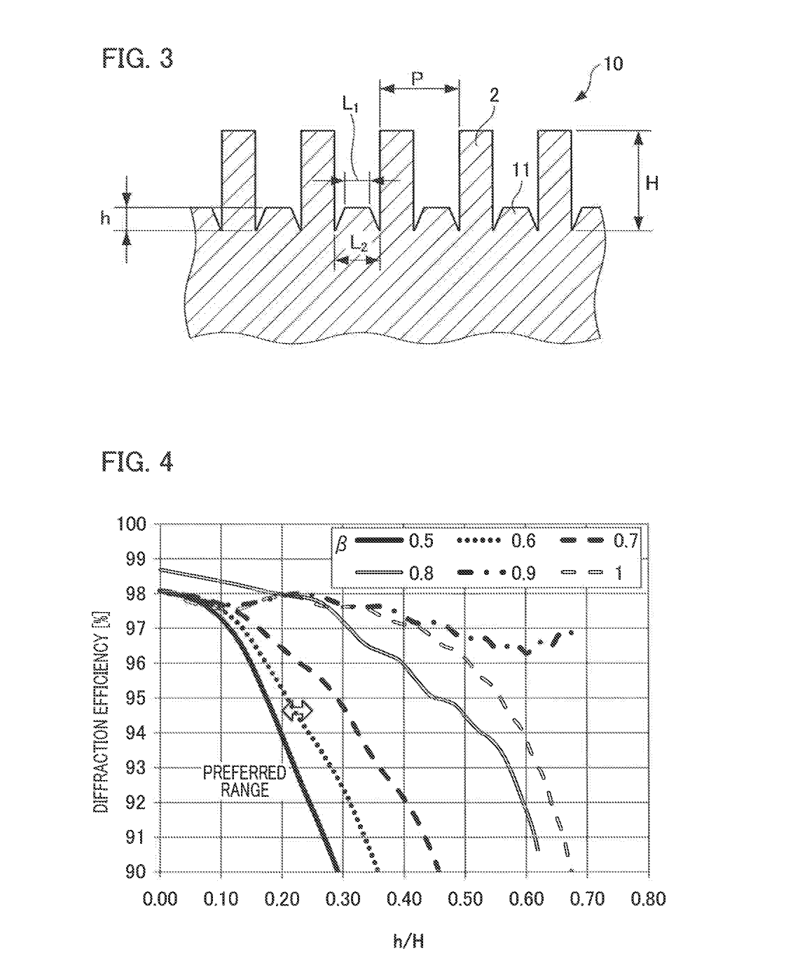

Next, a description will be given of a diffraction grating according to a second embodiment of the present invention. A feature of the diffraction grating according to the present embodiment lies in the fact that a sub-structure has a shape approximated by a trapezoid while an assumption is made in the diffraction grating 1 according to the first embodiment that the sub-structure 3 has a shape approximated by a triangle. FIG. 3 is a cross-sectional view illustrating a part of the shape of the diffraction grating 10 according to the present embodiment corresponding to the shape of the diffraction grating 1 of the first embodiment shown in FIG. 1. As in the diffraction grating 1 of the first embodiment, the diffraction grating 10 is a binary transmission type diffraction grating and is different from the sub-structure 3 of the first embodiment as shown in FIG. 3 in that the shape of the sub-structure 11 is approximated by a trapezoid as described above. Hereinafter, in FIG. 3, the portions having the same shape as those in the diffraction grating 1 shown in FIG. 1 are designated by the same reference numerals, and explanation thereof will be omitted.

In particular, in the present embodiment, the main structure 2 and the sub-structure 11 are set so as to have the following dimension. Firstly, the main structure 2 has an inter-grating pitch P of 800 nm and a duty σ of 0.49. In contrast, the sub-structure 11 is approximated by a trapezoid having a height of h, a lower base L₂ of a product of P×(1−σ), and an upper base L₁ of half of the lower base L₂. Here, the reference grating depth H₂ (corresponding to the reference grating depth H₁ of the first embodiment) of 1.38 μm when the height h is 0 μm is a preferred design value when the diffraction grating 1 is used in a wavelength λ of 800 nm at an incidence angle of 30°. Note that the reference diffraction efficiency e₂ at this time is 98.1% as a calculated value.

Next, as in the first embodiment, a parameter β (corresponding to the parameter α of the first embodiment) is introduced in relation to the ratio of the height h of the sub-structure 11 to the grating depth H of the main structure 2 so as to reference the diffraction efficiency e for each parameter β. As in FIG. 2 of the first embodiment, FIG. 4 is a graph illustrating the diffraction efficiency e with respect to the ratio (h/H) of the height h to the grating depth H for each parameter β. Here, the parameter β is defined based on the assumption that the grating depth H, the height h, and the reference grating depth H₂ are in the relationship of H=H₂+β×h. It can also be seen from FIG. 4 that the diffraction efficiency e with respect to the ratio h/H depends on the parameter β. Also, in this case, the diffraction efficiency e overall tends to decrease with an increase in the ratio h/H. However, the diffraction efficiency e locally increases greater than the reference diffraction efficiency e₂ in a range where the ratio h/H is from 0.20 to 0.25 inclusive when the parameter β is, for example, 0.90. In other words, if the diffraction grating 10 is formed by setting the target dimension such that the parameter β and the ratio h/H fall within such a range or a value, high diffraction efficiency e may be obtained as in the first embodiment even when the sub-structure 11 of which the shape is approximated by a trapezoid is present.

In the above embodiments, the diffraction grating is a transmission type diffraction grating having a repeating structure of projection and recess on the cross section thereof. However, the present invention is not limited thereto but may also be applicable to, for example, a reflection type diffraction grating which is made by forming a reflection film on the projection and the recess of a transmission type diffraction grating after creation thereof.

### (Optical Device)

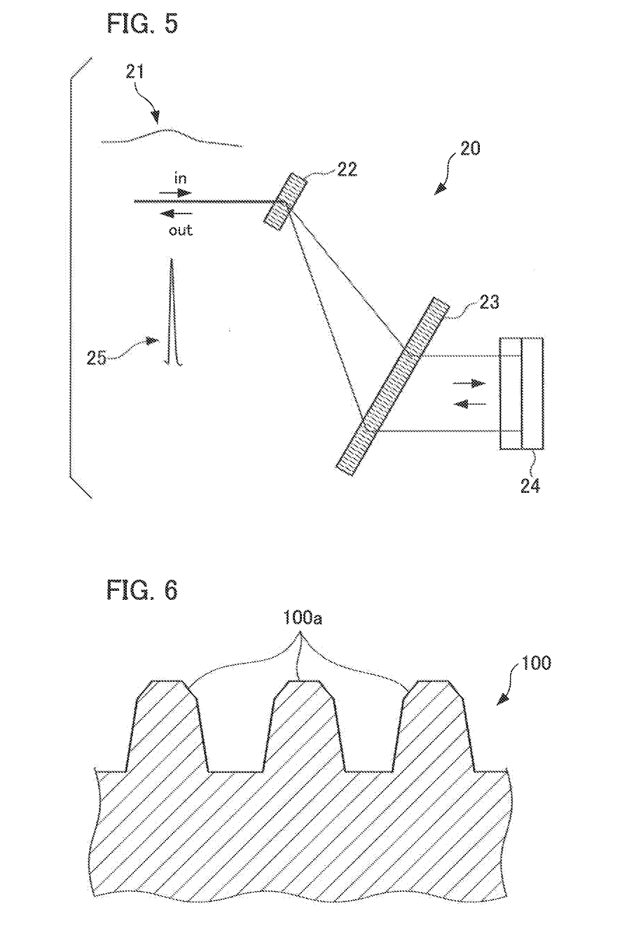

Next, a description will be given of an optical device according to one embodiment of the present invention. The diffraction grating 1 (or the diffraction grating 10) described in the above embodiments may be employed in various types of optical devices without limiting intended use. Hereinafter, a description will be given of an exemplary case where the diffraction grating 1 according to the above embodiments is employed for a pulse compression device serving as an optical device. FIG. 5 is a schematic view illustrating the configuration of a pulse compression device 20 which incorporates the diffraction grating 1 serving as a wavelength dispersive element. The pulse compression device 20 is an optical device that propagates pulse light 21 which has been stretched in advance to two diffraction gratings (first diffraction grating 22 and second diffraction grating 23) and a roof mirror 24 and then converts the pulse light into pulse light 25 with its pulse width compressed. In general, it is preferable that the diffraction grating employed for the pulse compression device exhibits high diffraction efficiency. Accordingly, the pulse compression device 20 employs the diffraction gratings 1 according to the above embodiments as two diffraction gratings (first diffraction grating 22 and second diffraction grating 23). With this arrangement, the pulse compression device 20 is advantageous for maintaining or improving, for example, compression efficiency. As described above, the optical device according to the present embodiment is advantageous, for example, for maintaining or improving optical performance.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefits of Japanese Patent Application No. 2012-244279 filed on Nov. 6, 2012, which is hereby incorporated by reference herein in their entirety.

What is claimed is:

1. A transmission-type diffraction grating having a repeating structure of projection and recess on at least one surface of a substrate, wherein a sub-structure of which the cross section is approximated as a triangle or a trapezoid is provided in the recess, and the height of the projection and the height of the sub-structure are set such that the ratio of the height of the sub-structure to the height of the projection is in the range of from 0.05 to 0.45.

2. The diffraction grating according to claim 1, wherein the ratio of the height of the sub-structure to the height of the projection is determined on the basis of diffraction efficiency according to the value of the height of the projection when it is assumed that the sub-structure is not present.

3. The diffraction grating according to claim 2, wherein, given that the height of the projection is H, the height of the sub-structure is h, the height of the projection when it is assumed that the sub-structure is not present is H₁, and a parameter is a, the parameter is related to Formula represented by formula: H=H₁+α×h.

4. The diffraction grating according to claim 3, wherein, when the shape of the sub-structure is approximated as a triangle and the diffraction grating is used in the Littrow arrangement, and when a used wavelength is 1,030 nm, an inter-grating pitch is 800 nm, the duty of the projection is 0.425, and the height of the projection when it is assumed that the sub-structure is not present is 1.5 μm, the parameter is in the range of from 0.52 to 0.88.

5. The diffraction grating according to claim 4, wherein the height of the projection and the height of the sub-structure are set such that the ratio of the height of the sub-structure to the height of the projection is in the range of from 0.20 to 0.45 when the parameter is 0.76.

6. The diffraction grating according to claim 4, wherein the height of the projection and the height of the sub-structure are set such that the ratio of the height of the sub-structure to the height of the projection is in the range of from 0.05 to 0.15 when the parameter is 0.52.

7. The diffraction grating according to claim 4, wherein the height of the projection and the height of the sub-structure are set such that the ratio of the height of the sub-structure to the height of the projection is 0.32 when the parameter is 0.64.

8. The diffraction grating according to claim 4, wherein the height of the projection and the height of the sub-structure are set such that the ratio of the height of the sub-structure to the height of the projection is 0.26 when the parameter is 0.88.

9. The diffraction grating according to claim 3, wherein, when the shape of the sub-structure is approximated as a trapezoid and the diffraction grating is used in the Littrow arrangement, and when a used wavelength is 800 nm, an inter-grating pitch is 800 nm, the duty of the projection is 0.49, and the height of the projection when it is assumed that the sub-structure is not present is 1.38 μm, the height of the projection and the height of the sub-structure are set such that the ratio of the height of the sub-structure to the height of the projection is in the range of from 0.20 to 0.25 when the parameter is 0.90.

10. The diffraction grating according to claim 1, wherein an anti-reflection film or an anti-reflection structure is provided on a surface not having the repeating structure.

11. An optical device including a diffraction grating, wherein the diffraction grating is a transmission-type diffraction grating having a repeating structure of projection and recess on at least one surface of a substrate, the recess has a sub-structure of which the cross section is approximated as a triangle or a trapezoid, and the height of the projection and the height of the sub-structure are set such that the ratio of the height of the sub-structure to the height of the projection is in the range of from 0.05 to 0.45.

12. The optical device according to claim 11, wherein the optical device is a compression device that compresses a pulse width of pulse light which is incident to the compression device and emits the pulse light.

13. The optical device according to claim 11, wherein at least one diffraction grating to be used is the diffraction grating and pulse light is made to propagate the diffraction grating and a roof mirror so as to compress the pulse width of the pulse light.

14. The optical device according to claim 11, comprising a mirror that reflects light from the diffraction grating and causes the light to be incident to the diffraction grating again.

15. The optical device according to claim 11, comprising a first diffraction grating and a second diffraction grating, and
wherein at least one of the first diffraction grating and the second diffraction grating is the diffraction grating.

16. A diffraction grating having a repeating structure of projection and recess on the surface of a substrate, wherein a sub-structure of which the cross section is approximated as a triangle or a trapezoid is provided in the recess, and the height of the projection and the height of the sub-structure are set such that the ratio of the height of the sub-structure to the height of the projection is in the range of from 0.05 to 0.45.
